(19) United States
(12) Patent Application Publication
(10) Pub. No.: US 2023/0373829 A1
(43) Pub. Date: Nov. 23, 2023

(54) METHOD FOR TREATING A WASTEWATER EFFLUENT BY DENSIFYING SLUDGE IN A SEQUENCING BATCH REACTOR

(71) Applicant: SUEZ INTERNATIONAL, PARIS LA DEFENSE CEDEX (FR)

(72) Inventors: Françoise PETITPAIN PERRIN, PARIS (FR); Alexis DAUNAY, PARIS (FR)

(21) Appl. No.: 18/029,628

(22) PCT Filed: Oct. 1, 2021
(86) PCT No.: PCT/EP2021/077091

§ 371 Date: Mar. 30, 2023

(30) Foreign Application Priority Data
Oct. 2, 2020 (FR) 2010109

(51) Int. Cl. C02F 3/12; C02F 3/30

(52) U.S. Cl. CPC C02F 3/1263; C02F 3/305; C02F 3/308; C02F 3/301; C02F 2209/42; C02F 2303/06; C02F 2101/105

(57) ABSTRACT

A method for treating a wastewater effluent includes carbon pollution, nitrogen pollution and phosphorus pollution, in a sequencing batch reactor (SBR), the SBR comprising: a chamber capable of containing a wastewater-sludge mixture comprising various levels; a sludge bed, comprising PAOs, located at the bottom of the chamber, above which a sludge blanket level is defined; means for determining a minimum level and a maximum level for extracting sludge in the chamber; extraction means capable of extracting sludge at variable levels between the minimum extraction level and the maximum extraction level; the method comprising: a step of supplying the SBR, during which an amount of effluent to be treated is introduced near the bottom of the chamber, in the sludge bed; a reaction sequence comprising: at least a first anaerobic step, during which the PAOs capture the carbon pollution and release phosphorus compounds; optionally, a second step of anoxic denitrification; a third aeration step, allowing the dephosphatation of the effluent by the PAOs to be carried out; a decanting step, during which sludge is deposited at the bottom of the chamber and the content of the chamber clarifies in the vicinity of its surface; a recovery step, during which a clarified fraction is drawn off from the content of the chamber, with the recovery and supply steps taking place simultaneously; and a step of extracting at least a portion of the light sludge at a predetermined level.

The invention is in the technical field of biological treatment of municipal and industrial wastewater and more specifically relates to the technology known as a Sequencing Batch Reactor (SBR).

An SBR operates in a sequenced manner with various treatment steps, and in particular a decanting phase that allows “activated” sludge to be separated from the treated water.

A method called “activated sludge” method uses biological purification in its wastewater treatment. It is a mode of purification using free cultures. The principle involves degrading the organic matter, suspended or dissolved in the wastewater, using bacteria. A good level of biodegradation is acquired by virtue of homogenization of the medium allowing the bacteria to access the particles and of good aeration. Then, the sludge is deposited in the bottom of the reactor during the decanting phase.

An activated sludge method aims to eliminate carbon pollution and nitrogen pollution, as well as to eliminate or recover the phosphorus contained in the phosphorus pollution. To ensure that the carbon pollution is eliminated, a bacterial culture rich in heterotrophic cells is therefore required. However, bacterial growth requires the presence of nutrients, in particular sources of nitrogen and phosphorus, such as those contained in the effluents and the elimination of which is also necessary.

Nitrogen treatment generally requires nitrification and then denitrification (N/DN) methods. Nitrification is an oxidation reaction using autotrophic bacteria, ammoniacal nitrogen or ammonium, often denoted N—NH₄, using:
nitrous nitrogen, also known as nitrite, N—NO₂;
then nitric nitrogen, also known as nitrate, N—NO₃.

In a known manner, biological nitrification treatment is carried out under aerobic conditions using autotrophic microorganisms capable of oxidizing the ammonium ions (NH₄⁺) to nitrite ions (NO₂⁻) and then to nitrate ions (NO₃⁻). This step is usually carried out in two sub-steps of nitritation and nitratation:

NH⁺₄⇒NO₂⁻⇒NO₃⁻

Denitrification involves reducing the gaseous nitrogen (or dinitrogen, also denoted N₂), using denitrifying bacteria, of the nitrates produced during the nitrification reactions. The biological denitrification treatment is typically carried out under anoxic conditions, using heterotrophic microorganisms capable of reducing the nitrate ions produced during the first treatment to nitrite ions, then the nitrite ions to gaseous nitrogen (N2).

More specifically, nitrification is broken down into two sub-steps: a first step of nitritation in the presence of oxygen, followed by a second step of nitratation, also in the presence of oxygen. Nitritation involves oxidizing ammonium to nitrite using autotrophic nitrite bacteria, known as AOB or “Ammonia Oxidizing Bacteria”, the predominant genus of which is Nitrosomonas. Nitratation involves oxidizing nitrite to nitrate using other autotrophic bacteria, known as NOB or “Nitrite Oxidizing Bacteria”, the predominant genus of which is Nitrobacter.

Denitrification also can be broken down into two sub-steps: a denitratation step, which will convert the nitrates into nitrites, and a denitritation step, which will convert these nitrites into gaseous nitrogen. Each of these two sub-steps is carried out using heterotrophic bacteria and requires large amounts of biodegradable carbon. Indeed, denitrification requires approximately 2.9 kilograms of carbon in the form of a 5-day Biological Oxygen Demand (DBO₅) to reduce a kilogram of N—NO₃ to dinitrogen.

In order to reduce the amounts of energy and carbon used for treating nitrogen, other metabolic routes can be contemplated: nitritation-denitritation and partial nitritation-deammonification.

The nitritation-denitritation method, also called “nitrate shunt”, attempts to stop oxidizing nitrogen in the nitrites stage while avoiding the production of nitrates, hence the shunt of the “nitrate part” of the cycle. In order to implement nitritation-denitritation, NOB (Nitrite Oxidizing Bacteria) therefore must be suppressed in favor of AOB (Ammonia Oxidizing Bacteria). According to the prior art, this method provides a saving of 25% in terms of the oxygen requirement and requires only 1.7 kilograms of carbon in the form of DBO₅ to reduce a kilogram of N—NO₂ to dinitrogen. This represents a saving of approximately 40% with respect to the carbon requirements compared to a conventional nitrification-denitrification method.

In a known manner, the nitritation treatment is carried out under aerobic conditions using autotrophic microorganisms capable of oxidizing the ammonium ions (NH4+) to nitrite ions (NO2−). The denitritation treatment is carried out under anoxic conditions using heterotrophic microorganisms capable of reducing the nitrite ions (NO2−) to dinitrogen (N2).

Another method, called partial deammonification or nitritation/Anammox (NP/A), uses the nitritation reaction described above but then involves anaerobic autotrophic bacteria, called Anammox “ANaerobic AMMonium Oxidation”, which consume ammonium and nitrite in order to produce N₂ without requiring oxygen and biodegradable carbon.

The first step of deammonification is partial nitritation (NP). It involves oxidizing a fraction (57%) of the ammonium ion to nitrite. The second step is carried out by the Anammox anaerobic bacteria. In this reaction, approximately 11% of the nitrogen load is converted into nitrate, which raises the theoretical maximum elimination rate to 89%.

The same bacterial population, namely the aerobic oxidizing bacteria (AOB), as that of N/DN is involved for partial nitritation. In this case, (i) only a fraction of the ammonium is oxidized, unlike the N/DN method that requires 100% oxidation of the NH₄ and (ii) the level of oxidation is reduced because the targeted molecule is NO₂ and not NO₃. According to the prior art, the oxygen savings for this treatment route amount to approximately 50% compared to a conventional nitrification and denitrification treatment.

Moreover, as the AOB and Anammox bacteria are autotrophic populations, the whole NP/A process can be carried out without any biodegradable carbon. No external (or exogenous) carbon needs to be added in order to carry out the nitrogen treatment. This treatment therefore does not allow the carbon that is possibly present to be eliminated.

In a known manner, the partial nitritation treatment is carried out under aerobic conditions using autotrophic microorganisms capable of oxidizing the ammonium ions (NH4+) to nitrite ions (NO2−). The anaerobic oxidation treatment is carried out under anaerobic conditions using autotrophic microorganisms capable of oxidizing the ammonium ions (NH4+) to dinitrogen (N2) in the presence of nitrite ions (NO2−) (Anammox bacteria).

Biological dephosphatation (i.e., treating phosphorus by the biological route) is carried out by successively implementing a treatment step under anaerobic conditions and a treatment step under aerobic conditions. Indeed, certain bacteria, called polyphosphate-accumulating organisms (or PAOs), have the particular feature of over-accumulating the phosphorus when they are subjected to alternating anaerobic and aerobic conditions. The PAOs release phosphates while under anaerobic conditions, and, when they then transition so as to be under aerobic conditions, they accumulate an amount of phosphates that is greater than that released under anaerobic conditions.

Consequently, by adapting the anaerobic/aerobic conditions of the chamber, the concentration of phosphates in the chamber of the SBR can be controlled by virtue of the intervention of the phosphorus-laden PAOs.

Irrespective of the treatment technology that is used, the SBR technology is limited in terms of its dimensioning by the decantability of the sludge. Indeed, one of the factors limiting the activated sludge concentration in an SBR, itself representing a potential for treating a polluting load, is the decantability of the sludge that is generally expressed using the Mohlman index. The Mohlman index is the index of the decantability of the sludge. This index defines the amount of activated sludge decanted in half an hour relative to the mass of dry residue (or the concentration of suspended matter, also denoted MES) of this sludge: the lower the index, the better the decanting capacity of the sludge.

The denser the sludge, the faster the decanting phase and the shorter the overall duration of the treatment cycle, which allows more pollution to be treated in the same day by carrying out a higher number of cycles.

Generally, denser sludge means that it is possible to work with higher concentrations, while allowing good decantability (index) and therefore means that more pollution can be treated in the same work volume.

A first reactor design, called sequencing batch reactor (SBR), uses two different volumes that are alternately used for reaction and for decantation, with the water being transferred from the reaction compartment to the decantation compartment (Seghers Unitank method). However, this type of SBR reactor has been improved, and most sequencing (SBR) type biological reactors are currently designed with a single volume, in which the various steps of the treatment occur successively. These reactors are generally variable-level reactors: the raw water supply phase and the treated water recovery phase are dissociated over time, so that when the treated water is recovered, the water level in the reactor lowers.

‘Constant-level’ SBR reactors are also known, which allow the time of each treatment sequence to be reduced, while maintaining the effectiveness of the treatment. Such a reactor is described, for example, in document WO 2016/020805.

In SBR-type reactors, the sludge decanting most easily, that is to say, the heaviest sludge, is generally found in the bottom part of the sludge bed. However, it is this sludge that is extracted during each cycle at the end of the decanting period, which tends to select the lightest sludge, which is also the least decantable.

The SBR method described in WO 2004/024638 aims to overcome this problem. This involves a constant-level SBR method, which implements aerobic granular sludge, the particular feature of which is to decant very quickly (with a decanting speed of more than 10 m/h). However, the formation of the granules with an urban/municipal effluent, that is to say, with a low concentration of pollution (carbon, nitrogen, phosphorus), takes a long time, and its stability as a function of the incoming loads and of the temperature variations has not been proven to date.

International application WO 2019/053114 proposes further improving the SBR method described in WO 2004/024638 by proposing an SBR reactor allowing, using means for determining a minimum level and a maximum level for extracting sludge in the SBR chamber, selective extraction of the granular sludge exhibiting the best decantability.

Therefore, a requirement exists for a method for treating activated sludge using an SBR that is more competitive, that is to say, more intense, and that is capable of operating with any type of sludge, including non-granular sludge. Furthermore, the method of the invention advantageously allows an amount of wastewater to be treated that is identical to, or even greater than, those of the methods of the prior art, but with a limited footprint.

The invention aims to overcome all or some of the aforementioned problems by proposing a method called “densifying sludge” method, allowing high sludge decanting speeds to be achieved, irrespective of the nature of the sludge (whether or not it is granular), and advantageously with non-granular sludge. The sludge is densified in a constant-level SBR by optimizing the production of easily-decantable microorganisms, by virtue of the combination of several factors:
a supply through the sludge bed;
the order of the sequences implemented in the wastewater treatment, allowing populations of particular microorganisms to be developed, exhibiting good decantability, in particular the PAOs (Phosphate Accumulating Organisms); and the sludge extraction strategy, which allows the sludge with the best decantability to be kept in the reactor, by extracting the least decantable sludge on each cycle.

To this end, the aim of the invention is a method for treating a wastewater effluent comprising carbon pollution, nitrogen pollution and phosphorus pollution, in a sequencing batch reactor (SBR), said SBR comprising:
a chamber capable of containing a wastewater-sludge mixture comprising various levels, with each level being defined by a sludge concentration and/or density;
a sludge bed, comprising PAOs, located at the bottom of the chamber, above which a sludge blanket level is defined;
means for determining a minimum level and a maximum level for extracting sludge in the chamber;
extraction means capable of extracting sludge at variable levels between the minimum extraction level and the maximum extraction level;
   said method comprising:
a step of supplying the SBR, during which an amount of effluent to be treated is introduced near the bottom of the chamber, in the sludge bed, preferably via a distribution network covering the bottom of the chamber;
a reaction sequence comprising:
   at least a first anaerobic step, during which the PAOs capture the carbon pollution and release phosphorus compounds;
   optionally, a second step of (partial and/or total) denitrification under anoxic conditions, with this step being implemented only in the case of an NOx concentration that is greater than a predetermined threshold;
   a third aeration step, allowing the dephosphatation of the effluent by the PAOs to be carried out, with the aeration being controlled so as to simultaneously carry out either (partial or total) nitrification, or (partial or total) nitritation;
a decanting step, during which sludge is deposited at the bottom of the chamber and the content of the chamber clarifies in the vicinity of its surface;
a recovery step, during which a clarified fraction is drawn off from the content of the chamber, with said recovery and supply steps taking place simultaneously, so as to keep the level of the content of the chamber substantially constant during the recovery and supply steps; and
a step of extracting at least a portion of the light sludge at a predetermined level between the minimum extraction level and the maximum extraction level, preferably in the vicinity of the sludge blanket. According to one particular embodiment, the method of the invention is made up of the above steps, and, if applicable, one or more optional steps described below.

Advantageously, the treatment method according to the invention further comprises a step of measuring the sludge blanket, and the step of extracting at least a portion of the light sludge is carried out when the measurement of the sludge blanket is substantially equal to a predetermined distance from the sludge extraction level.

Advantageously, the step of extracting at least a portion of the light sludge is carried out during the supply step and/or during the decanting step.

Advantageously, the treatment method according to the invention comprises, during the reaction sequence, a step of injecting air into the chamber.

Advantageously, the third aeration step is followed by a step of post-denitrification under anoxic conditions, preferably implemented when the third step is a total or partial nitrification step; or the third aeration step is followed by a step of denitritation under anoxic conditions, preferably implemented when the third step is a total or partial nitritation step; or the third aeration step is followed by a step of deammonification under anoxic conditions, preferably implemented when the third step is a partial nitritation step.

Advantageously, the decanting step is preceded by a step of injecting air into the chamber.

Advantageously, the treatment method according to the invention comprises a step of densifying sludge using a densification device inside the chamber.

Advantageously, the treatment method according to the invention comprises a step of controlling the duration of the third aeration step as a function of the level of pollution (in particular carbon, nitrogen and phosphorus pollution) of the wastewater effluent.

A “granular sludge” is characterized by a decanting speed that is greater than 10 m/h, and a sludge index (“sludge volume index”, measured according to standard NF EN 14702-1 dated July 2006) that is less than 35 mL/g (as particularly mentioned in application WO 2004/024638, page 3). A sludge that does not meet these two conditions at the same time is not considered to be a granular sludge. For example, a non-granular sludge is a sludge having a decanting speed that is less than or equal to 10 m/h. Consequently, for a granular sludge, the sludge index at 5 minutes is equal to the sludge index at 30 minutes.

A “densified sludge”, also called heavy sludge, is characterized by sludge indices ranging between 35 and 100 mL/g, preferably between 40 and 80 mL/g, more preferably between 40 and 70 mL/g, and decanting speeds ranging between 2.0 and 9.0 m/h. It is also characterized by a mass proportion of 10% to 50% (preferably 20% to 40%) of particles with a particle size that is greater than 100 μm (up to 1,000 μm, preferably between 200 μm and 500 μm), and a high mass proportion (between 50% and 90%) of biological flocs with a particle size that is less than 100 μm (advantageously less than 200 μm). This densified sludge can also be characterized by the limit mass flow criterion that is greater than or equal to 8 kg MES·m⁻²·h⁻¹, preferably greater than or equal to 8.5 kg MES·m⁻²·h⁻¹. This is a mixture of solids, liquids and microorganisms, with said microorganisms including polyphosphate-accumulating organisms laden with phosphorus. This heavy sludge exhibits very good decantability.

A “light sludge” is characterized by sludge indices that are greater than 100 mL/g and decanting speeds that are less than 2 m/h. It is also characterized by a mass proportion of biological flocs having a size of less than 0.2 mm ranging between 15 and 50%. This light sludge can also be characterized by the limit mass flow criterion that is less than 8 kg MES/m²/h. It is a mixture of solids, liquids and microorganisms. This sludge comprises little or even no PAOs. This light sludge is difficult to decant.

The “decanting speed” is expressed in meters/hour (m/h). It can be determined from the Kynch curve, which is acquired by observing the decantation of a sample in a 1 L test piece under gravity. It should be noted that the value at 30 minutes of the Kynch curve allows the Molhman index (SVI, “Sludge Volume Index”) or the sludge index (raw sludge dilution, DSVI (Diluted SVI)) to be acquired, according to standard NF EN 14702-1-July 2006. On a pilot-scale or industrial reactor, the decanting speed can be deduced from the evolution of the height of the sludge blanket over time, during a non-aerated sequence. The height of the sludge blanket can be measured continuously, for example using an ultrasound probe. Alternatively, it can be discontinuous, it is then possible to take manual samples at various levels over the height of the reactor at predetermined intervals.

The “limit mass flow” is expressed in kg·m⁻²h⁻¹. It characterizes the amount of suspended solid matter (also denoted MES) that can be decanted per unit area and time, and measures the drop speed that sludge can have at a given concentration. The limit mass flow is determined from the Kynch curve, by diluting or concentrating the raw sludge several times in succession.

The “proportion of biological flocs” is expressed as % by weight of sludge, associated with a size, for example the percentage below 0.2 mm. This value can be acquired by screening a sludge sample on screens with various mesh sizes (for example, 200 μm/400 μm/500 μm/800 μm/1 mm/1.25 mm). The concentration of MES (suspended matter) of the filtrate that is acquired is then measured, which is then added to the MES concentration of the raw sludge (as %).

The “size of the biological flocs” corresponds to a particle size, in particular the maximum size of the particles. It can be determined using a statistical analysis based on microscopy photographs.

Advantageously, the method of the invention does not include a step of recirculating light sludge in the sequencing batch reactor.

The invention will be better understood and further advantages will become apparent upon reading the detailed description of an embodiment that is provided by way of an example, which description is illustrated by the accompanying drawing, in which:

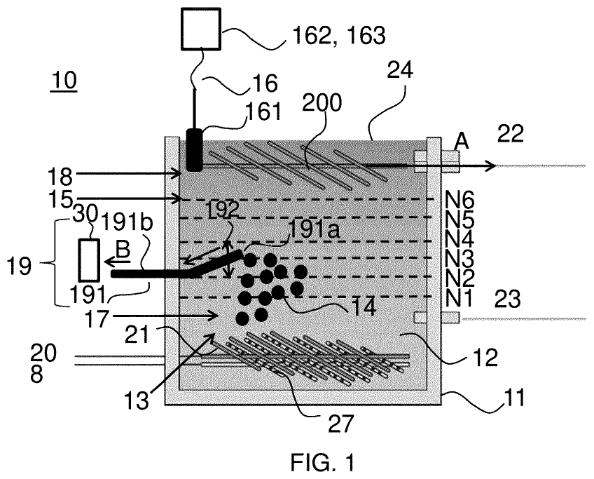

FIG. 1 schematically shows an example of a sequencing batch reactor suitable for implementing the treatment method of the invention;

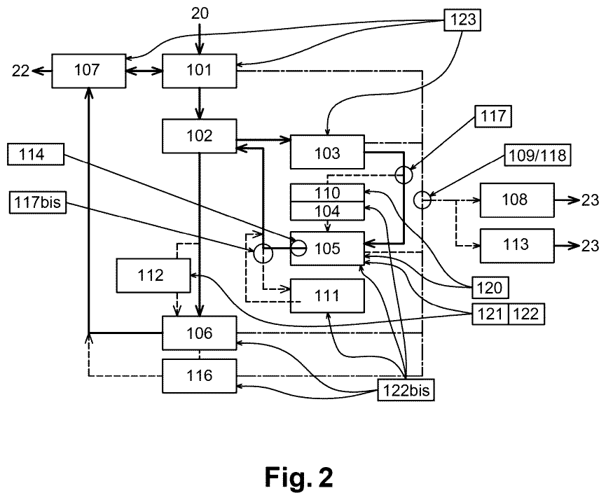

FIG. 2 shows a flowchart of the steps of the method for treating a wastewater effluent according to the invention;

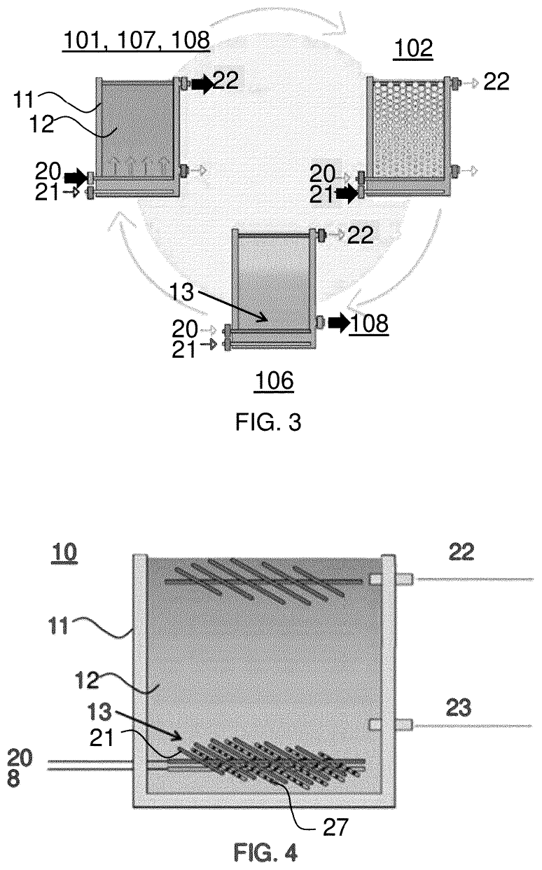

FIG. 3 schematically shows the steps of the method for treating a wastewater effluent according to the invention;

FIG. 4 schematically shows a sequencing batch reactor implemented according to the method of the invention;

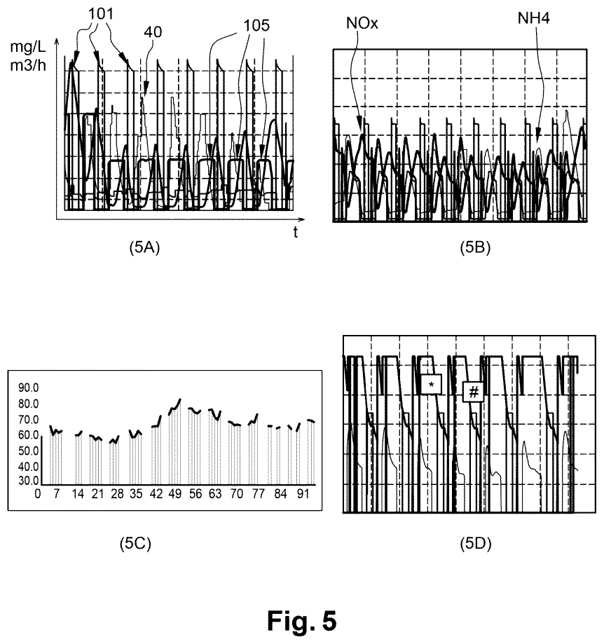

FIGS. 5A, 5B, 5C, 5D illustrate the selection of the bacterial population as a function of the reaction sequence using measurements carried out during the treatment method according to the invention;

FIG. 6 schematically shows the chamber of the SBR and the recovery means during the supply and recovery steps;

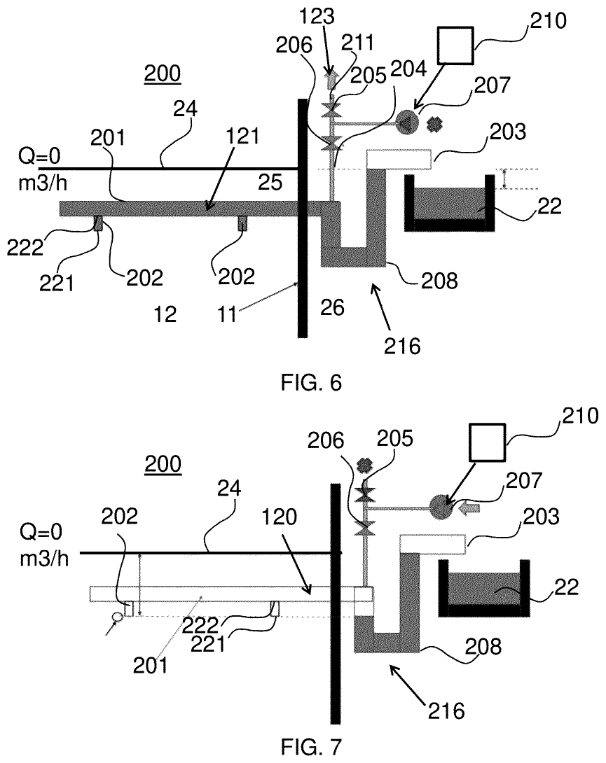

FIG. 7 schematically shows the chamber of the SBR and the recovery means during the decanting step.

In these figures, for the sake of clarity, the scales are not followed. Moreover, the same elements will use the same reference signs in the various figures.

FIG. 1 schematically shows an example of a sequencing batch reactor suitable for implementing the treatment method of the invention. The method of the invention is aimed at treating a wastewater effluent 20 comprising carbon pollution, nitrogen pollution and phosphorus pollution, in a sequencing batch reactor (SBR) 10. The SBR 10 comprises a chamber 11 capable of containing a wastewater-sludge mixture 12 comprising various levels, with each level being defined by a sludge concentration and/or density. Each height in the chamber 11 corresponds to a sludge concentration and/or density of the content 12. For example, several levels can be defined, denoted N1, N2, N3, N4, N5, N6. Each of the levels can have a different sludge concentration and/or density from the other levels, or several levels can have the same sludge concentration and/or density. Finally, during a phase of the treatment method, as will be explained in further detail below, all the levels in the assembly have the same sludge concentration and/or density. The chamber 11 is supplied with effluent 20 to be treated, advantageously via a distribution network 21, preferably covering the bottom of the chamber, and with air 8 via a distribution network 27, preferably covering the bottom of the chamber.

The SBR 10 comprises a sludge bed 13, schematically shown, comprising PAOs 14, located at the bottom of the chamber 11, above which a sludge blanket level 15 is defined. The SBR 10 comprises means 16 for determining a minimum level 17 and a maximum level 18 for extracting sludge in the chamber 11. In FIG. 1, these levels are shown schematically. Their determination will be described below.

When treating wastewater, the chamber 11 contains a wastewater-sludge mixture 12. When the sludge has decanted, the treated water is located in the upper part of the chamber of the reactor. The water can be withdrawn via an opening under the level of the surface 24 of the chamber 11 using a sampling system 200 capable of taking the clarified fraction, and comprises or is made up of an immersed pipe, through which the water can be drawn and taken outside the chamber (arrow A). Another alternative embodiment of the recovery means is described below.

The heaviest and/or densest sludge particles are found at the bottom of the chamber 11 and they can be withdrawn from the bottom wall of the chamber. The rest of the mixture is located between the two, with the rest of the mixture being in the form of a stratification, that is to say, which has several levels N₁, N₂, N₃, N₄, N₅, N₆, . . . , with each level being defined by a sludge concentration and/or density in the mixture 12.

The sludge blanket 15 is the level from which the sludge is located. It is defined by the height between the surface 24 of the content of the chamber and the presence of sludge in the assembly. The level of the sludge blanket 15 can be determined by the determination means 16, preferably continuously. Alternatively, it can be measured manually using a Secchi disk. The sludge blanket can be measured continuously. However, it is not worthwhile measuring during the homogenization phases since the content of the chamber is mixed, and the sludge present has not yet decanted.

The reactor 10 according to the invention allows the sludge that is the least capable of decanting and that is found in the mixture 12 to be selectively extracted.

The SBR 10 comprises extraction means 19 capable of extracting sludge 23 (schematically shown for the sake of understanding) at variable levels between the minimum extraction level 17 and the maximum extraction level 18 (arrow B). By way of an example, and in a non-limiting manner, the extraction means 19 can comprise an extractor 191 comprising at least one first part having at least one opening 191a inside the chamber 11 and one second part 191b capable of withdrawing the sludge outside said chamber. The extraction means 19 can comprise variation means 192 capable of varying the position of the opening 191a of said extractor 191, in particular the level of said opening between the minimum extraction level 17 and the maximum extraction level 18. The extractor 191 advantageously comprises a (suction) pump or a gravity valve (not shown) for extracting sludge. Advantageously, the extractor 191 can comprise a set of tubes disposed at various levels in the chamber 11, with each tube having a first end having an opening inside the chamber 11 and a second end connected to the second part 191b of the extractor 191, and variation means 192 comprising a set of valves capable of opening or closing said tubes. The extraction means thus allow sludge to be extracted at one or more variable levels. To improve the readability of the figure, the extraction means 19 are shown on the left part of the SBR, but the second part 191b for withdrawing the sludge is to be connected to the extracted sludge 23.

The means 16 for determining the minimum level 17 and the maximum level 18 for extracting the sludge 23 in the chamber 11 can comprise measurement means 161 capable of measuring the concentration at various levels of a wastewater-sludge mixture. For example, a sludge blanket probe allows the surface of the sludge bed to be measured. An MES (Suspended Matter) probe allows the concentration of the sludge to be measured. Several probes can be disposed over the height of the chamber in order to measure the concentration of suspended matter at various levels. These measurements are used to determine the levels 17, 18. The means 16 can comprise selection means 162 capable of selecting a maximum sludge concentration value and a minimum sludge concentration value. The selection can be made by an operator or on the basis of a computation linked to the age of the sludge. The means 16 can comprise deduction means 163 capable of deducing a minimum extraction level corresponding to the selected maximum concentration value and a maximum extraction level corresponding to the selected minimum concentration value.

The measurement means 161 can comprise, for example, one or more measurement probes, in particular concentration probes. Said measurement probe allows the concentration of sludge in the mixture to be measured. The measurement probe 161 is immersed in the mixture as illustrated. It can be at a fixed or variable immersion depth depending on the type of probe that is selected. Alternatively, as stated above, there can be several measurement probes over the height of the chamber. The measurement probe 161 is connected to the selection means 162, which make it possible to check whether or not the measurement corresponds to sludge to be extracted, and to the deduction means 163, which allow the measurement to be connected to the corresponding level. These determination means 16 are connected to sludge extraction means 19, more specifically to the means 192 for varying the extraction level, mainly for selecting the extraction level. The variation means 192 vary the level of the opening 191a of the extractor 191, or it is possible to selectively extract at fixed extraction levels and at variable instants according to the evolution of the content, for example during the step of decanting, waiting, supplying/recovering, during the anaerobic step, according to the measurement of the sludge blanket, or even non-selectively during the aeration step.

For example, and in a non-limiting manner, the measurement means 161 of the determination means 16 comprise an ultrasound sensor immersed below the surface of the wastewater-sludge mixture. The ultrasound sensor allows an ultrasound wave to be sent into said mixture (it then operates as a transmitter) and then allows an ultrasound wave to be received back after having traveled a given distance in the wastewater-sludge mixture (it then operates as a receiver). The sensor is connected to the selection means 162 and to the deduction means 163.

FIG. 2 shows a flowchart of the steps of the method for treating a wastewater effluent according to the invention. The treatment method according to the invention comprises:
a step 101 of supplying the SBR 10, during which an amount of effluent 20 to be treated is introduced near the bottom of the chamber 11, in the sludge bed 13, preferably via a distribution network 21 covering the bottom of the chamber 11, in order to mix the wastewater to be treated with the sludge of the sludge bed;
a reaction sequence 102 comprising:
   at least a first anaerobic step 103, during which the PAOs 14 capture the carbon pollution and release phosphorus compounds;
   optionally, a second step 104 of (pre-)denitrification under anoxic conditions, with this step being advantageously implemented in the case of an NOx concentration that is greater than a predetermined threshold; a third aeration step 105, allowing the dephosphatation of the effluent by the PAOs 14 to be carried out, with the aeration being controlled so as to simultaneously carry out either (partial or total) nitrification, or (partial or total) nitritation;
a decanting step 106, during which sludge is deposited at the bottom of the chamber 11 and the content of the chamber 11 clarifies in the vicinity of its surface 24;
a recovery step 107, during which a clarified fraction 22 is drawn off from the content of the chamber, with said recovery 107 and supply 101 steps taking place simultaneously, so as to keep the level of the content of the chamber 11 substantially constant during the recovery 107 and supply 101 steps; and
a step 108 of extracting at least a portion of the light sludge 23 at a predetermined level between the minimum extraction level 17 and the maximum extraction level 18, preferably in the vicinity of the sludge blanket 15.

Typically, the supply step 101 is carried out under anaerobic conditions, or even anoxic conditions. In this latter case, the step 101 under anoxic conditions allows denitrification or denitritation. The anaerobic step 103 is carried out under anaerobic conditions, the aeration step 105 is carried out under aerobic conditions. Preferably, the decanting step 106 is carried out at least partially under anoxic conditions.

The second step 104 can be linked to a step 117 of measuring the NOx concentration in the chamber.

The treatment method according to the invention can also optionally comprise a fourth anoxic denitrification or denitritation or deammonification step 111. More specifically, three alternative embodiments will be contemplated primarily: according to the first alternative embodiment, the third step 105 comprises total or partial nitrification, and the anoxic step 111 involves denitrification (post-denitrification method); according to a second alternative embodiment, the third step 105 comprises total or partial nitritation, and the anoxic step 111 involves denitritation (post-denitritation method); finally, according to a third alternative embodiment, the third step 105 comprises partial nitritation, and the anoxic step 111 involves deammonification (method called “ANAMMOX”). The fourth step 111 can be linked to a step 117bis of measuring the NOx concentration in the chamber.

The step 101 of supplying through the sludge bed allows the sludge to be brought into contact with the raw water to be treated. The amount of wastewater 20 to be treated is introduced through the sludge bed where the PAOs are located. Thus, the particles and the soluble fraction of the amount introduced are made accessible to the bacteria. By virtue of the anaerobic step 103, the PAOs capture the carbon pollution and release phosphate compounds. The aeration step 105 allows dephosphatation of the content of the chamber by the PAOs. The reaction sequence 102 contributes to the development of PAOs that exhibit good decantability. During the decanting step 106, the sludge is deposited into the bottom of the chamber under gravity. The heavy sludge and the PAOs deposit more quickly than the light sludge. They add to the sludge bed. The light sludge is not as decantable. It remains suspended in the content of the chamber for longer, above the sludge bed.

The step 108 of extracting at least a portion of the light sludge allows regular, or at the very least at predetermined times, for example during each cycle, extraction of the least decantable sludge. However, the extraction does not necessarily occur during each cycle depending on the operating constraints. For example, extraction may not occur over weekends. As a result, only the sludge exhibiting good decantability is retained in the chamber of the SBR. In addition to treating the pollution present in the introduced effluent, the combination of the action of the PAOs producing denser sludge and of the extraction of the light sludge densifies the sludge present in the chamber. As a result, the method of the invention, called densifying sludge method, allows high sludge decanting speeds to be acquired, irrespective of the nature of the sludge present in the chamber of the SBR.

During the reaction sequence 102, when said sequence comprises a second step 104, it is possible to have a step 110 of injecting air into the chamber 11. Injecting air into the chamber before step 104 allows the biomass to be suspended for better mixing with the oxidized nitrogen-rich supernatant (nitrate NO3 and nitrite NO2), which improves the efficiency of the denitrification of the supply step 104, and also the efficiency of the first anaerobic step 103. It should be noted that this step 110 is optional, if the optional second step 104 is activated, depending on the NOx concentration measurement.

The decanting step 106 can be preceded by a step 112 of injecting air into the chamber 11. Injecting air into the chamber before the decanting step allows the content of the chamber to be homogenized and the sludge to be brought into contact with the oxidized nitrogen species. Furthermore, injecting air also allows the dinitrogen present in the content of the reactor to be degassed.

Furthermore, the treatment method according to the invention can comprise a step 113 of densifying sludge using a densification device 30 inside or outside the chamber 11, preferably inside. The densification device 30 can be a sieve of suitable size downstream or upstream of the sludge extraction means, in order to retain the largest flocs and to thus improve the selection, that is to say, their retention in the chamber, of the particles that are decanting most easily. Alternatively or in addition, the step of densifying the sludge can involve adding ballasts (such as zeolites).

Advantageously, the treatment method according to the invention comprises a step 114 of controlling the duration of the third aeration step 105 as a function of the level of pollution of the wastewater effluent 20, in particular as a function of the concentration of NH4 and/or of the NO₂⁻ and/or of the NO₃⁻ of the content of the chamber. More specifically, it is the pollution of the raw water that is measured indirectly as soon as the content of the chamber is aerated at least once.

FIG. 3 schematically shows the steps of the method for treating a wastewater effluent according to the invention. During the steps 101 of supplying the SBR with effluent to be treated and 107 of recovering a clarified fraction of the content of the chamber, the chamber is filled with wastewater 20 and forms a mixture 12 and the pollution undergoes a biological treatment. During this phase, the wastewater is introduced into the chamber. The liquid level in the chamber is kept constant by opening a treated water valve (clarified fraction), for example. In other words, the treated water is recovered at the same time as the raw water (wastewater) is supplied. The flow rate of treated water is always the same as the supply flow rate.

At this stage, denitrification (exogenous denitrification under anoxic conditions in the bottom of the sludge bed and endogenous denitrification under anoxic conditions in the upper level of the chamber) and the bio-dephosphatation process begin. The biological treatment of the effluent mainly occurs during the reaction sequence 102:
the carbon is removed and the ammoniacal nitrogen undergoes nitrification during the aeration step 105;
the phosphorus is released during the anaerobic step 103, and reabsorbed during the aeration step 105;
denitrification occurs during specific anoxic periods. If the sedimentation and supply duration is not sufficient, there is a pre-denitrification period (exogenous denitrification under anoxic conditions) and/or a post-denitrification period (endogenous denitrification).

Next, the decanting step 106 is carried out. It is during this step that the treated water is separated from the sludge by static sedimentation only. Some biological activity occurs when the liquid undergoes an endogenous denitrification in contact with the layer of sludge. During this step, the steps 101 of supplying the chamber and 107 of recovering from the chamber are not allowed. The content of the chamber is at rest in order to allow decanting of the sludge. At the end of the decanting step 106, the sludge exhibiting good decantability (the heavy sludge) is found in the bottom of the chamber, and the sludge with poor decantability (the light sludge) is suspended in the content of the chamber, between the bottom of the chamber and the sludge blanket. The clarified fraction is located in the upper part of the chamber, in the vicinity of its surface 24. At the end of the decanting step 106, the excess biological sludge can be extracted in order to maintain the age of the sludge necessary for nitrification and/or nitritation as a function of the temperature, which can be measured during a temperature measurement step 118. Alternatively, the excess biological sludge can be selectively extracted during the decanting step 106, and/or during the supply step 101 and the recovery step 107, and/or during the anaerobic step 103 and/or the waiting step 116. The sludge can be non-selectively extracted during the aeration step 105.

The step 108 of extracting at least a portion of the light sludge 23 is carried out at a predetermined level between the minimum extraction level 17 and the maximum extraction level 18, preferably in the vicinity of the sludge blanket 15. Indeed, the light sludge is located at the level of the sludge blanket. The predetermined level of extraction of the light sludge is not necessarily a fixed level over time. This level is susceptible to evolve depending on the biological treatment and the flow rate of wastewater introduced into the chamber of the SBR. The extraction means 19 allow extraction at any level. The light sludge can thus be extracted at variable levels during cycles of the treatment method. From a practical point of view, several fixed extraction levels can be defined, for example three. Furthermore, depending on the measurement of the sludge concentration and/or density at various levels of the wastewater-sludge mixture in the chamber and/or on the measurement of the sludge blanket, it is possible to select which level from among the three levels can be used for the extraction. To this end, the method according to the invention can comprise a step 109 of measuring the sludge blanket 15, and the step 108 of extracting at least a portion of the light sludge is carried out when the measurement of the sludge blanket 15 is substantially equal to a predetermined distance from the extraction level of the sludge.

As the level of the sludge bed can vary over time, sludge extraction levels are advantageously installed in the height of the chamber, between the bottom and the middle of the height for the heavy sludge and between two levels over the height of the chamber for the light sludge. For example, an extraction level can be located 50 cm above the bottom of the chamber in order to eliminate excessively old sludge (mineralized), with the other extraction points being able to be located over the height of the chamber. In FIG. 3, the arrows shown in bold indicate the open inlets/outlets allowing the flow of the corresponding flow depending on the phase of the method.

FIG. 4 schematically shows a sequencing batch reactor 10 implemented according to the method of the invention. The various phases set forth above occur in the same chamber and are separated over time. Consequently, the step 101 of supplying the chamber with effluent is managed intermittently. However, in order to ensure continuous treatment of the effluents, several chambers operate at the same time and are supplied alternately. The principle of the invention similarly applies to several chambers.

During the supply step 101, the raw water is distributed at the bottom of the chamber, for example through a network 21 of perforated pipes. After the decanting step 106, and at the same time as the supply step 101, the supernatant clarified water is withdrawn from the upper part of the chamber using, for example, a network of perforated recovery pipes. Particularly advantageous means for recovering the clarified fraction are described below.

The light sludge can be selectively extracted during the decanting step 106 and/or during the step 101 of supplying and 107 of recovering and/or during the first anaerobic step 103 just at the level of the sludge blanket in order to eliminate the lightest sludge particles.

Non-selective sludge extraction (in particular heavy but also light sludge) can also be contemplated during the aeration step 105 and/or during step 110 and/or during step 112, when the content 12 is homogeneous.

FIGS. 5A, 5B, 5C, 5D illustrate the selection of the bacterial population as a function of the reaction sequence using measurements carried out during the treatment method according to the invention.

The supply of raw water (readily biodegradable carbon) through the sludge bed, followed by a strict anaerobic sequence and then an aerobic sequence, leads to the selection of dephosphating bacteria (PAOs) capable of accumulating phosphates in the form of granules of intracellular polyphosphates.

FIG. 5A shows the release (anaerobic) followed by the reabsorption of the P—PO4 during an aeration period (aerobic). The curve referenced 40 clearly shows the operation of the biological dephosphatation with a significant release of P—PO4 as soon as the reactor is under anaerobic conditions. An increase in the curve can be seen, followed by a decrease as soon as the aeration acts, which decrease corresponds to the re-absorption of the released P—PO4 and of that provided by the raw water. This corresponds to the biological over-accumulation of phosphorus.

FIG. 5B shows the nitrification (decrease of the NH4 curve and increase of the NO_{X} curve), with the endogenous denitrification (first part of the decrease of the NO_{X} curve) and the exogenous denitrification (second part of the decrease of the NO_{X} curve after supplying). The curve clearly shows the benefit of the exogenous denitrification for intensifying the denitrification reaction with respect to the endogenous denitrification with a much steeper slope and therefore higher kinetics after the easily biodegradable carbon-rich supply. This bacterial population, as well as the PAOs, generates exopolymers that naturally tend to densify the flocs. These dense flocs are not granular sludge, the decanting speed of this sludge is between 2 and 10 m/h, preferably between 3 and 6 m/h and their Mohlman index (or sludge index) is approximately 65 mL/g. A granular sludge has particles (or granules) that are always bigger than 200 micrometers, while in this case the densified sludge can contain a proportion of particles smaller than 200 micrometers.

In order to further increase the fraction of dense flocs in the sludge, the treatment method according to the invention applies a sludge extraction strategy that allows the lightest sludge to be eliminated. This results in a faster decanting speed, since only the sludge with good decantability remains in the chamber.

The method according to the invention can also comprise a waiting phase 116 coupled to the supply, decanting or anaerobic steps.

Considering that the light sludge is found at the top of the sludge bed, in particular at the end of the decanting step 106 and/or during the waiting step 116, and/or during the supply step 101 and/or during the recovery step 107 and/or during the first anaerobic step 103 (the heaviest sludge has dropped to the bottom from the start of decanting), the sludge is extracted at the level of the sludge blanket (or slightly below) at the end of decanting 106 and/or during the waiting step 116 and/or during the supply 101 and/or during the recovery step 107 and/or during the first anaerobic step 103.

The light sludge can also be extracted from the start of decanting, but at a higher level in the reactor. It is also possible for this extraction to be carried out at the end of aeration, at any level of the chamber, since the content is homogeneous over the entire height of the chamber and therefore has light sludge. It is also possible to contemplate extracting the light sludge at the very beginning of a supply stage or when supplying since the light sludge is the first to rise, or during the anaerobic reaction sequence.

The method of the invention is based on the selection combining the moment of the extraction of the light sludge and the height at which this extraction is carried out. The selected height is also associated with the age of the sludge to be maintained within the reactor by the duration and the extraction flow rate. The target sludge age can be determined from a measurement of the temperature of the water/sludge mixture in the reactor.

The treatment method according to the invention can further comprise a step 109 of measuring the sludge blanket 15, and the step 108 of extracting at least a portion of the light sludge is carried out when the measurement of the sludge blanket 15 is substantially equal to a predetermined distance from the extraction level of the sludge. The strategy for extracting light sludge is improved by measuring the sludge blanket in order to trigger the extraction of the light sludge at a given level, when the level of the sludge blanket is at a predetermined distance from the extraction level of the sludge, whether this level is reached during the decanting step or during the supply step or during the anaerobic reaction sequence. By virtue of this measurement, and optionally that of the temperature of the water/sludge mixture in the reactor, it is also possible to take into account the instantaneous drop speed (or residual supply speed) and the duration required for the extraction in order to perfect this self-optimized extraction mode, preferably integrating the notion of dynamic sludge age. By proceeding as such, sludge extraction allows the lightest sludge located slightly above the sludge blanket, more specifically on the upper part thereof, to be eliminated for each sequence, by adequately calibrating the sludge blanket probe.

The method of the invention allows the daily variations in the flow rate that the chamber can experience to be taken into account. At night, the supply flow rate is low, the difference between the supply speed and the decanting speed is significant, the sludge blanket quickly approaches the extraction point. Conversely, during daily hydraulic peaks, the difference between the supply speed and the decanting speed is low, the descent of the sludge blanket is slowed down. Controlling the moment and the duration of the extraction with the measurement of the sludge blanket ensures that the lightest sludge is always extracted at a given level by modifying the extraction time from one cycle to the next.

Combining the supply and recovery steps, of the reaction sequence and of the decanting step, with the step of extracting light sludge leads to the acquisition of a denser sludge than that of a conventional activated sludge. This results in sludge being acquired in a highly stable manner that has a decanting speed that is greater than 2 m/h and is less than 10 m/h, of the order of 3 m/h to 6 m/h and a Mohlman index that is close to 65 mL/g (+/−10 mL/g). The method of the invention is based on this combination that allows a densified but non-granular sludge to be acquired.

FIG. 5C illustrates the stability of the sludge index during pilot tests at a value of less than 75 mL/g substantiating densified sludge with good decantability. The results are shown for a period of 91 days (abscissa axis).

The benefit of this densification is clearly that of being able to simultaneously and safely manage two opposite flows, the raw water supply and the decanting of the sludge, without dragging sludge into the treated water while applying raw water supply speeds of more than 2 m/h.

Experiments at various supply speeds (less than 4 m/h) show that, when supplying, the decanting speed is slowed down but the decantation continues to be carried out when supplying raw water.

FIG. 5D shows the sludge blanket with a supply at 17 m3/h, that is, 2.266 m/h. The upper curve shows, on the descending part, the reduction of the sludge blanket in the phase noted (*) when decanting and in the phase noted (#) when supplying. On the graph, it can be seen that the decanting speed is much higher than the supply speed and that the sludge blanket continues to decrease when supplying.

While the duration of the various sequences of a reactor of the SBR type is generally fixed, the method according to the invention also allows the duration of the reaction sequence 102 to be adapted in real time, by virtue of the installation of suitable sensors and probes, in order to take into account variations in the concentration of the pollution and of the hydraulic flow rate as a function either of the time of day (loading point) or in order to take into account the dilution of the effluent linked to rainy weather. Furthermore, synchronizing the cycles by implementing a waiting phase can be set up.

In particular, setting up an NH4 measurement, which may or may not be supplemented by a measurement of NOx (in particular NO2), in the reactor can allow its evolution to be monitored during the aerated nitrification phase and to be stopped as soon as a predetermined value is reached.

The benefit is to be able to reduce the aeration period when the water is diluted (nighttime period or rainy weather hydraulic point). The reduction of the duration of the aeration period also allows the energy consumption to be optimized, and more cycles to be carried out per day, and therefore allows more pollution to be treated compared to an operation with a fixed aeration period. Conversely, during peaks in pollution, the duration of the aeration phase will be increased, while being longer on the loading points than during low loads, in order to allow the conversion of the NH₄ up to the defined value and thus guarantee the acquisition of the performance capabilities in the case of peaks in concentration of NH₄.

Finally, the treatment method according to the invention can comprise a step 117 of measuring the NOx concentration in the chamber in order to ensure that this value is low enough before transitioning to the supply and recovery step to allow the release of the phosphorus, under anaerobic conditions, by the dephosphatating bacteria and thus ensure good operation of the biological dephosphatation. This measurement will then be carried out at the end of step 106, or preferably at the end of step 105. If the measured NOx concentration is still too high, an additional step of treating nitrogen can be carried out in order to reach the desired NOx concentration threshold.

The total duration of a cycle and the supply duration are generally fixed in order to be able to manage a continuous supply over several chambers. The supply duration is also fixed, with the total duration of the cycle generally being four times the supply duration. This means that the sum of the duration of the reaction sequence and of the decanting time is three times the supply duration. Nevertheless, the method of the invention also applies to a variable cycle duration.

The method of the invention thus provides significant flexibility. In particular, it is possible to adapt the duration of the steps, in particular the decanting step, the supply and recovery step, and the anoxic step, as a function of the hydraulic regime and of the load to be treated.

The invention also relates to a facility for treating a wastewater effluent comprising carbon pollution, nitrogen pollution and phosphorus pollution. The facility comprises a sequencing batch reactor (SBR), said SBR 10 comprising:
a chamber capable of containing a wastewater-sludge mixture 12 comprising various levels, with each level being defined by a sludge concentration and/or density;
a sludge bed 13, comprising PAOs 14, located at the bottom of the chamber, above which a sludge blanket level 15 is defined;
means 16 for determining a minimum level 17 and a maximum level 18 for extracting sludge in the chamber;
extraction means 19 capable of extracting at least a portion of the light sludge 23 at a predetermined level between the minimum extraction level and the maximum extraction level;
a device for supplying the SBR with an amount of effluent to be treated near the bottom of the chamber, in the sludge bed, preferably via a distribution network covering the bottom of the chamber, preferably in the vicinity of the sludge blanket;
a device for recovering a clarified fraction of the content of the chamber; means for aerating the chamber.

The facility is arranged and equipped for implementing the treatment method described above.

In the present invention, the term “recovery” is used as a synonym of the term “draining”, and is basically intended to indicate discharging the treated water from the chamber.

FIG. 6 schematically shows the chamber of the SBR and an embodiment of the recovery means during the supply and recovery steps, and FIG. 7 schematically shows the chamber of the SBR and the recovery means during the decanting step. Throughout the remainder of the description, the term recovery/reuse is to be understood as evacuation/evacuate and/or drain/draining. The aeration of the content of the chamber is carried out with air 8 via a distribution network 27, preferably covering the bottom of the chamber 11. In this embodiment of the invention, the means 200 for recovering the clarified fraction of the content 12 of the chamber 11 comprise:
a recovery duct 201 extending below the surface 24 of the content 12 of the chamber 11, between the inside 25 and the outside 26 of the chamber, comprising:
   at least one channel 202 hydraulically connecting the content 12 of the chamber 11 and the recovery duct 201;
   a recovery orifice 203, through which the clarified fraction of the content 12 of the chamber 11 is intended to be discharged;
   an air duct 204 hydraulically or aeraulically connecting the recovery duct 201 with the atmosphere;
an air exhaust valve 205 on the air duct 204, capable of assuming an open position or a closed position, by which the air blocked in the recovery duct can be discharged into the atmosphere;
an air/water blocking device 216 on the recovery duct 201, capable of blocking the air in the recovery duct 201 upstream of the air/water blocking device 216 and capable of blocking the water downstream of the air/water blocking device 216;
an air injector 207 connected to the recovery duct 201 and intended to supply the recovery duct 201 with over-pressurized and/or compressed air.

The recovery means 200 can comprise an air injector 207 (advantageously having a non-return valve) connected to the air duct 204 between the exhaust valve 205 and the air/water blocking device 216 and intended to supply the recovery duct 201 with over-pressurized/compressed air.

The air/water blocking device 216 can be a valve, preferably motorized, that can assume the open or closed position or a U-shaped siphon that can be primed or unprimed. Throughout the remainder of the description, the air/water blocking device 216 is said to be open if the valve is in the open position or the siphon is primed, and is said to be closed if the valve is closed or the siphon is unprimed.

The recovery means 200 can comprise an air injector 207 connected to the air duct 204 between the exhaust valve 205 and the air/water blocking device 216 and can be intended to supply the recovery duct 201 with over-pressurized/compressed air. The air for blocking the recovery duct can alternatively originate from the air source used in the treatment method. More specifically, the air injector 207 can be dedicated to blocking air/water. In this case, it comprises a non-return valve. The air injector 207 may also not be dedicated to blocking air/water, that is to say, the air injector can originate from the supply of air to the chamber. In this case, the recovery means 200 further comprise a blocking valve 206 for providing the blocking function. The air injector 207 is not necessarily connected to the air duct 204, but it is systematically connected to the recovery duct 101 in order to block it with air/water.

The air injector 207 can operate intermittently during the aeration step 105 or continuously.

The exhaust valve 205 corresponds to a vent valve.

The means 210 for controlling the recovery means 200 aim to fill the recovery duct 201 with air until the recovery duct 201 completely empties itself of the clarified fraction contained in the recovery duct 201, to keep the recovery duct 201 filled with air during the aeration step 105 and during the decanting step 106, and to discharge the air contained in the recovery duct 201 via the clarified fraction 22 during the supply step 101 and the recovery step 107. More specifically, the control means 210 are configured to actuate the valve 205 and the blocking device 216 as required so that the recovery duct empties itself of the clarified fraction present in the recovery duct 201 and keep the recovery duct 201 filled with air during the aeration phase and the decanting phase. The air can be supplied continuously. It can also originate from an external air source, that is to say, not dedicated to blocking air/water, and designed for the aeration of the chamber. In the case of an external air source, an isolation valve 206 is required. In the case whereby the recovery means 200 comprise an air injector 207 dedicated to blocking air/water, said injector can inject over-pressurized and/or compressed air into the recovery duct 201. It should be noted that this dedicated air injector 207 has a non-return valve (not shown in the figures). In other words, the recovery duct 201 is then blocked with air it is filled with air that then cannot escape due to the closure of the air/water blocking device 216 and the exhaust valve 205. During the aeration phase, the level of the content of the chamber increases due to the introduction of air into the chamber and the level of the content rises. The level of the content of the chamber rises. However, since the recovery duct is filled with air, this content cannot enter the duct. This has the advantage of avoiding a loss of sludge from the system (with the presence of sludge being important for densifying), and of avoiding the contamination of the recovery duct and of the clarified water exiting the orifice 203 (this is important with respect to the tertiary treatment that should be implemented downstream, and/or with respect to the rejection standards), the channels 202 make it possible to compensate for the gaseous retention raising the water level of the reactor subject to aeration, they also compensate for imperfect horizontality of the piping.

The content rises in the channels 202 in the event of an injection of discontinuous air, but cannot enter the recovery duct 201. This configuration guarantees, by virtue of the control of the recovery means, that only the clarified fraction enters the recovery duct, without any risk of the content containing sludge entering therein.

It is important to highlight that the recovery duct extends below the surface 24 of the content of the chamber. It is therefore permanently immersed in the content of the chamber. The channels 202, which are tubes with an inlet orifice, are permanently immersed and are filled with the content of the chamber (with clarified water (during the supply/recovery step and the anaerobic step) or with air (the reaction step, including the aeration step, and the decanting step)). In other words, the content of the channels varies depending on the current sequence. The channels 202 have a dual role: they form an access to the clarified fraction toward the recovery duct 201 during the supply/recovery step, and they form a buffer volume, without access to the recovery duct 201, which contains the content of the chamber when the level of the content of the chamber increases due to the aeration. The transition from the role of accessing the recovery duct to that of the buffer volume occurs according to the progress of the treatment method, by virtue of the injection/discharge of over-pressurized and/or compressed air and the opening/closing of the blocking device and of the exhaust valve. The injection/discharge of over-pressurized and/or compressed air and the opening/closing of the blocking device and of the exhaust valve are controlled by the control means 210 of the recovery means 200.

In one embodiment, the air/water blocking device 216 comprises a U-shaped siphon 208 between the air duct 204 and the recovery orifice 203. When air is injected, the clarified water contained in the siphon and in the recovery duct is replaced by air up to a height equivalent to the end of the one or more channels. By this means, the siphon is intended to hydraulically disconnect the content of the chamber from the clarified water outside the chamber, it is thus unprimed. By extending the height of the siphon, it is also possible to compensate for the elevation of the level of the surface 24 during the aeration step. The presence of a siphon is not compulsory and other embodiments are possible and will be set forth below. The siphon can be associated with a blocking valve 206 that is also controlled by the control means 210 if the air for filling the recovery duct originates from the air for the treatment (air injector 207 not dedicated to blocking air). The recovery orifice 203 is the orifice through which the treated water is discharged.

The recovery orifice 203 is advantageously positioned above the level of the recovery duct 201. Furthermore, advantageously, the recovery duct 201 comprises an air exhaust duct 211. In this case again, other embodiments are possible and will be set forth below.

With this embodiment of the recovery means, the method of the invention comprises, following the decanting step 106, during which sludge is deposited at the bottom of the chamber 11 and the content of the chamber 11 clarifies in the vicinity of its surface 24, a step 107 of recovering the clarified fraction 22 of the content of the chamber 11, with said recovery 107 and supply 101 steps occurring simultaneously so as to keep the level of the content of the chamber 11 substantially constant during the recovery 107 and supply 101 steps.

The treatment method according to the invention can also comprise a waiting phase 116 coupled to the supply, decanting or anaerobic steps.

According to the invention, the treatment method comprises:
a step 120 of controlling the recovery means 200, during which step the recovery duct 201 is filled with air until the recovery duct 201 completely empties itself of the clarified fraction 22 contained in the recovery duct 201, and the recovery duct 201 is kept filled with air during the reaction sequence 102 and preferably also during the decanting step 106, and optionally the waiting step; and
a step 123 of expelling the air contained in the recovery duct 201 by the clarified fraction 22 during the supply step 101 and the recovery step 107.

After step 120 and before step 123, the method can comprise a step 121 of at least partially filling the at least one channel 202 with the content 12 of the chamber 11 during the aeration step 105, if the air injection is not continuous during the air injection steps.

Furthermore, the treatment method comprises, between step 120 and step 123, two other steps of keeping the recovery duct filled with air. As mentioned above, the step 120 of filling the recovery duct 201 with air occurs by injecting air and draining clarified water simultaneously. The valve 205 is closed and the air/water blocking device 216 is said to be closed, the air injection device (the air injector 207) is operating, at the beginning of the first aeration step 105.

Next, the method comprises a step 122 of keeping the recovery duct 201 filled with air by injecting air. The valve 205 is closed and the air/water blocking device 216 is said to be closed, the air injection device 207 is operating, during the aeration step 105.

Next, the method comprises a step 122bis of keeping the recovery duct filled with air without injecting air. The valve 205 is closed and the air/water blocking device 216 is said to be closed, the air injection device 207 is stopped, during the aeration 105 and decanting 106 steps.

Next, the step 123 of expelling the air contained in the recovery duct and simultaneously filling with clarified water occurs. The valve 205 is opened and the blocking device 216 is said to be open, the air injection device 207 is stopped, during the supply 101, recovery 107 and anaerobic 103 steps.

Then, finally, if the injection of air is not continuous during the aeration step 105, in particular in order to save energy, a step 121 of at least partially filling the at least one channel 202 with the content 12 of the chamber 11 during the aeration step 105 can occur (but this step is not intended as such). In this case, it is possible to re-inject air in order to re-fill the recovery duct 201, it is step 122. This can be carried out in a syncopated manner by adjusting a frequency and an air injection duration or in a more precise manner by integrating a level measurement probe that makes it possible to detect whether air is to be re-injected and a step 122 is to be triggered during the aeration step 105.

The recovery duct is kept filled with air during the reaction sequence comprising the aeration step. Preferably, it is also kept filled with air during the decanting step. Indeed, if the recovery duct was no longer filled with air at the beginning of decanting, the sludge blanket would not have enough time to descend below the inlet orifices of the channels 202, which would cause contamination of the recovery duct by the sludge.

The particular feature of the invention lies in the positioning of the recovery duct 201 below the surface 24 of the content of the chamber, that is to say, it is always immersed. In other words, its content is controlled by virtue of the step (120, 122, 122bis, 123) of controlling the recovery means 200 as a function of the steps of the treatment method. As a result, only the treated water can enter the recovery duct in order to be recovered. The recovery duct is shown substantially horizontal, that is to say, parallel to the surface 24 of the content of the chamber, but it could also be inclined and extend along an axis secant to the plane in which the surface 24 is located. The first advantage is not to limit the volume of the chamber since the plane of water does not need to be lowered below the recovery duct in order to prevent untreated water and sludge from entering during the aeration step 105. By virtue of the control of the recovery means, the recovery duct is filled with air immediately before the step 105 of aeration of the reactor. In other words, the recovery duct is filled with air, that is to say, it is blocked with air and thus made inaccessible to the content of the chamber during the phases where the content of the chamber in the vicinity of the duct is not only treated water. Another particular feature is derived from the channel (or channels) 202 that hydraulically connect(s) the content of the chamber 11 to the recovery duct 201. They are shown perpendicular to the surface 24, but can also be inclined downward. The channel 202 plays a predominant role: while ensuring the hydraulic connection between the clarified fraction and the recovery duct in order to allow the clarified fraction to be recovered, it also allows, during the aeration step, the elevation of the level of the content of the chamber to be held. The channel 202 has two ends (visible in FIG. 4): a first end 221 and a second end 222 in direct contact with the recovery duct 201, allowing the flow between the recovery duct 201 and the channel 202. The channel 202 can have any section: circular, rectangular, polygonal, etc., as can the recovery duct 201.

The aeration step 105 leads to a variation in the level of the content of the chamber due to the injection of air into the chamber. During the aeration step 105, the channel (or channels) 202 at least partially fills with the content of the chamber. This is the particular case of step 121, for a method in which the injection of air into the recovery duct is not continuous. The filling height of the channels 202 corresponds to the elevation height of the content of the chamber. Since the channels 202 are dimensioned to be high enough in order to address the particular case of step 121, the content 12 does not reach the second end 222 of the channels 202. The recovery duct 201, itself, remains filled with air. During the aeration step 105, the content of the chamber is homogeneous, even at the surface 24. By virtue of the channels 202, this homogeneous content containing sludge does not enter the recovery duct 201. The channels 202 form a transition zone between the air-blocked recovery duct and the content of the chamber. The ends 221 of the channels 202 can be in contact with the water and the sludge. The ends 222 of the channels 202 are never in contact with sludge. Thus, it is guaranteed that the recovery duct, depending on the phases, contains either air or treated water, but never sludge.

The recovery duct 201 is kept filled with air during the reaction sequence 102 and preferably the decanting step 106, and optionally the waiting phase 116. This is step 122bis. At the end of decanting, the sludge present in the chamber is deposited at the bottom of the chamber 11 and the content of the chamber 11 clarifies in the vicinity of its surface 24. The method then comprises a step 123 of expelling air from the recovery duct 201. The valve 205 is in the open position and clarified water enters the recovery duct and allows the air blocked in the recovery duct to be expelled via the valve 205 and via the vent duct. There is no longer any air blocked in the recovery duct.

Subsequently, the air/water blocking device 216 is placed in what is called an open position and a new cycle starts: the supply step 101 occurs at the same time as the recovery step 107. By introducing an amount of effluent into the chamber, the same amount is drained in order to maintain a substantially constant level. Since the recovery duct is no longer air-blocked, the recovery duct 201 and the channels 202 are filled with this amount of the content 12 of the chamber 11 located at the surface 24. This is the clarified fraction intended to be recovered.

Controlling the filling of the recovery duct (step 120) with air and blocking the air in the recovery duct (step 122bis, optionally supplemented with step 122 if the injection of air is not continuous) results in precise control of the instant at which the content is let into the recovery duct. The recovery duct can access the content of the chamber when the content of the chamber is clarified on its surface. However, during the aeration step where the content is homogeneous, that is to say, when the content of the chamber is not clarified in the vicinity of the recovery duct, the recovery duct cannot access this content. In other words, the method according to the invention enables precise control of what enters the recovery duct. According to the steps of the wastewater treatment, there is a succession of phases of blocking the recovery duct with air and of phases of free hydraulic connection during which the content of the chamber can circulate in the recovery duct.

As a result, this alternative embodiment is based on a step of controlling the means for recovering the chamber of the SBR, during which, immediately before the aeration is put into service in the SBR, the recovery duct is filled with air until the duct completely empties itself of the water (clarified) contained in the duct. This alternative embodiment of the invention guarantees the non-contamination of the water recovery duct treated with activated sludge during the aeration by virtue of controlled air filling of the recovery duct as a function of the steps of the treatment method.

More generally, it will be apparent to a person skilled in the art that various modifications can be made to the embodiments described above, in the light of the teaching that has just been disclosed. In the following claims, the terms used should not be understood as limiting the claims to the embodiments set forth in the present description, but must be understood in order to include all the equivalents thereof that the claims aim to cover due to their wording and the provision of which is within the scope of a person skilled in the art based on their general knowledge.

1. A method for treating a wastewater effluent comprising carbon pollution, nitrogen pollution and phosphorus pollution, in a sequencing batch reactor (SBR), said SBR comprising:
a chamber capable of containing a wastewater-sludge mixture comprising various levels, with each level being defined by a sludge concentration and/or density;
a sludge bed, comprising PAOs, located at the bottom of the chamber, above which a sludge blanket level is defined;
means for determining a minimum level and a maximum level for extracting sludge in the chamber;
extraction means capable of extracting sludge at variable levels between the minimum extraction level and the maximum extraction level;
said method comprising:
a step of supplying the SBR, during which an amount of effluent to be treated is introduced near the bottom of the chamber, in the sludge bed, preferably via a distribution network covering the bottom of the chamber;
a reaction sequence comprising:
at least a first anaerobic step, during which the PAOs capture the carbon pollution and release phosphorus compounds;
optionally, a second step of (partial and/or total) denitrification under anoxic conditions, with this step being implemented only in the case of an NOx concentration that is greater than a predetermined threshold;
a third aeration step, allowing the dephosphatation of the effluent by the PAOs to be carried out, with the aeration being controlled so as to simultaneously carry out either (partial or total) nitrification, or (partial or total) nitritation;
a decanting step, during which sludge is deposited at the bottom of the chamber and the content of the chamber clarifies in the vicinity of its surface;
a recovery step, during which a clarified fraction is drawn off from the content of the chamber, with said recovery and supply steps taking place simultaneously, so as to keep the level of the content of the chamber substantially constant during the recovery and supply steps; and
a step of extracting at least a portion of the light sludge with a sludge index that is greater than 100 mL/g and a decanting speed of less than 2 m/h at a predetermined level between the minimum extraction level and the maximum extraction level, preferably in the vicinity of the sludge blanket.

2. The treatment method as claimed in claim 1, further comprising a step of measuring the sludge blanket, and wherein the step of extracting at least a portion of the light sludge is carried out when the measurement of the sludge blanket is substantially equal to a predetermined distance from the sludge extraction level.

3. The treatment method as claimed in claim 1, wherein the step of extracting at least a portion of the light sludge is carried out during the supply step and/or during the decanting step.

4. The treatment method as claimed in claim 1, comprising, during the reaction sequence, a step of injecting air into the chamber.

5. The treatment method as claimed in claim 1, wherein the third aeration step is followed by a step of post-denitrification under anoxic conditions, preferably implemented when the third step is a total or partial nitrification step; or the third aeration step is followed by a step of denitritation under anoxic conditions, preferably implemented when the third step is a total or partial nitritation step; or the third aeration step is followed by a step of deammonification under anoxic conditions, preferably implemented when the third step is a partial nitritation step.

6. The treatment method as claimed in claim 1, wherein the decanting step is preceded by a step of injecting air into the chamber.

7. The treatment method as claimed in claim 1, comprising a step of densifying sludge using a densification device inside the chamber.

8. The treatment method as claimed in claim 1, further comprising a step of controlling the duration of the third aeration step as a function of the level of carbon, nitrogen and phosphorus pollution of the wastewater effluent.
